(19) United States
(12) Patent Application Publication
(10) Pub. No.: US 2022/0144467 A1
(43) Pub. Date: May 12, 2022

(54) MOLDING STATION FOR MOLDING PACKAGING TRAYS

(71) Applicant: MULTIVAC SEPP HAGGENMUELLER SE & CO. KG, Wolfertschwenden (DE)

(72) Inventor: Sascha PETERMICHL, Lautrach (DE)

(73) Assignee: MULTIVAC SEPP HAGGENMUELLER SE & CO. KG, Wolfertschwenden (DE)

(21) Appl. No.: 17/523,122

(22) Filed: Nov. 10, 2021

(30) Foreign Application Priority Data
Nov. 10, 2020 (DE) 102020129551.0

(51) Int. Cl. B65B 31/02; B65B 51/14

(52) U.S. Cl. CPC B65B 31/028; B65B 51/14

(57) ABSTRACT

The disclosure relates to a molding station for molding packaging trays, wherein the molding station comprises an upper tool and a lower tool which can be moved relative to one another, and the lower tool comprises at least one receptacle for a packaging blank. The molding station further comprises a frame that is connected to the lower tool in a movable manner and that is arranged between the upper tool and the lower tool. The lower tool comprises at least one clamping mechanism for fixating a packaging blank in the receptacle. The clamping mechanism comprises a clamping element which can be actuated by a motion of the frame relative to the lower tool and is configured to fixate a packaging blank in the receptacle.

### CROSS-REFERENCE TO RELATED APPLICATIONS

This application claims foreign priority benefits under 35 U.S.C. § 119(a)-(d) to German patent application number DE 10 2020 129 551.0, filed Nov. 10, 2020, which is incorporated by reference in its entirety.

### TECHNICAL FIELD

The present disclosure relates to a molding station for molding packaging trays and a method for molding packaging trays by way of a molding station.

### BACKGROUND

Molding stations for molding packaging trays are basically known from prior art. These molding stations typically comprise two parts that are movable relative to one another, known as the upper tool and the lower tool.

Packaging blanks, such as trays made of cardboard (including paperboard), are inserted manually or in an automated manner into the lower tool. The upper tool positions a film to be molded onto the packaging blank over the packaging blank and the film is drawn in the direction of the packaging blank by applying a vacuum and nestles thereagainst, whereby the packaging tray is molded. In order to make the film moldable, it can be heated by the upper tool.

Once the film has been molded onto the packaging blank, the upper tool and lower tool are moved apart again. This can lead to an entrainment effect or the packaging being raised when the upper tool is removed from the lower tool. This can lead to misalignment of the packaging, which is problematic for downstream processes or for the removal of the packaging.

### SUMMARY

Proceeding from known prior art, a technical problem to be solved consists of specifying a molding station with which the upper tool is released from the lower tool with a reduced risk of a molded packaging tray being entrained.

This object may be satisfied by a molding station for molding packaging trays according to the disclosure or a method for molding packaging trays according to the disclosure.

The molding station according to the disclosure for molding packaging trays comprises an upper tool and a lower tool which can be moved relative to one another, where the lower tool comprises at least one receptacle for a packaging blank, where the molding station further comprises a frame that is connected to the lower tool in a movable manner and that is arranged between the upper tool and the lower tool, where the lower tool comprises at least one clamping mechanism for fixating a packaging blank in the receptacle, and where the clamping mechanism comprises a clamping element which can be actuated by a motion of the frame relative to the lower tool and is configured to fixate a packaging blank in the receptacle.

The motion of the upper tool and the lower tool relative to one another takes place in order, for example, to position a film relative to the packaging blank, which film can then be molded onto the packaging blank by way of the molding station in order to mold a packaging tray. This can be done, for example, by deep-drawing, where a vacuum or negative pressure is applied to the side of the lower tool, so that the film is drawn in the direction of the packaging base body and nestles thereagainst.

In this sense, a “packaging tray” is presently and hereafter to be understood to be the combination of the packaging blank and a film (made of any material) that is at least in part molded onto the shape of the packaging base body.

Due to the clamping mechanism, which is moved by the frame that is arranged between the lower tool and the upper tool, the clamping action for fixating the packaging blank can be precisely adjusted and also the duration of the fixation can be precisely adjusted. This prevents the packaging trays from being entrained when the upper tool is removed.

It is provided in one embodiment that the clamping mechanism comprises a movable anchor and the clamping element is arranged in a guide, where the clamping mechanism is configured to convert a motion of the frame relative to the lower tool into a motion of the anchor and, due to the motion of the anchor, to cause a motion of the clamping element in the guide.

This movable anchor is preferably arranged to be movable relative to the clamping element so that the clamping element can be moved in the guide, for example, also due to the contour of the anchor. This allows for mechanically reliable control of the motion of the clamping element and is not dependent on separate motors or other devices. This also results in a reliable synchronization with the motion of the frame.

In a further development, the anchor and/or the guide and/or the clamping element have a shape which is such that they can cause a motion of the clamping element that is not uniform over the length of the stroke of the frame. In this sense, a non-uniform motion is to be understood to mean that the motion amplitude of the clamping element changes over the length of the stroke of the frame. This can be implemented in such a way that, for example, there is no motion of the clamping element over a first portion of the length of the stroke of the frame, a motion with a low amplitude then takes place over a second portion, and a motion with a greater amplitude takes place over a third portion of the length of the stroke. In this way, special requirements regarding the motion of the clamping element can be taken into account.

It can be provided that the molding station comprises at least two receptacles and that the clamping mechanism is configured as a common clamping mechanism for the fixation of packaging blanks in the at least two receptacles. The structural complexity of the molding station and in particular of the clamping mechanisms for fixating also several packaging blanks can then be kept as low as possible, which also reduces the susceptibility of the molding station to faults.

It is provided in a further development of this embodiment that the common clamping mechanism comprises two clamping elements, where one of the respective clamping elements is associated with one of the at least two receptacles and the clamping elements can be actuated simultaneously by a motion of the frame relative to the lower tool. In particular, moving the clamping elements can be done synchronously by a single element, for example, by a single anchor. This configuration reduces the structural complexity of the molding station and improves operational reliability.

Furthermore, it can be provided that two clamping mechanisms are associated with each receptacle of the molding station, where each clamping mechanism comprises a clamping element and the clamping elements are arranged to fixate a packaging blank on opposite sides. The fixation of the packaging blank is then ensured in a reliable manner.

The clamping element in one embodiment comprises a friction element on a side facing the receptacle, where the friction element comprises an outer surface with a material having a high coefficient of friction with respect to at least one of cardboard, natural fiber, paper, bamboo, plastic material. With this embodiment, the packaging blank is prevented from slipping away from the clamping elements, even when the clamping pressure of the clamping elements on the packaging blank is low.

Furthermore, the frame can comprise an opening corresponding to the receptacle so that a packaging blank can pass through the opening when the frame is moved towards the lower tool. The frame can then at least in part “dive” under the packaging blank and/or the receptacle for the packaging blank and the upper tool can be reliably positioned for applying a film.

In one embodiment, the frame is connected to the lower tool by way of a restoring element which can cause the frame to be restored to an initial position when the lower tool and the upper tool are moved apart, and/or the clamping mechanism comprises a restoring element which can cause the clamping element to be restored to a release position when the lower tool and the frame are moved apart. Unintentional or undesired locking of the frame in its position that is approached to the lower tool or of the clamping mechanism in the clamping position is then prevented, which despite the fixation of the packaging blank ensures that the packaging blank is released from the receptacle e.g., at a certain point in time.

As a further aspect of the disclosure, a method is furthermore provided for molding packaging trays by way of a molding station, where the molding station comprises an upper tool and a lower tool which are movable relative to one another, where the lower tool comprises at least one receptacle for a packaging blank, where the molding station further comprises a frame that is connected to the lower tool in a movable manner and that is arranged between the upper tool and the lower tool, where the lower tool comprises at least one clamping mechanism for fixating the packaging blank in the receptacle and where the clamping mechanism comprises a clamping element which is actuated by a motion of the frame relative to the lower tool and fixates a packaging blank in the receptacle, where the frame is moved in the direction of the lower tool by a motion of the lower tool and the upper tool towards one another, and the clamping element is thereby actuated for fixating the packaging blank in the receptacle.

Packaging trays can be reliably molded using this method, where the risk of the packaging tray being entrained by the upper tool is minimized.

The clamping mechanism in one embodiment comprises a movable anchor and the clamping element is arranged in a guide, where the clamping mechanism converts a motion of the frame relative to the lower tool into a motion of the anchor and where the motion of the anchor causes a motion of the clamping element in the guide. A motion of the clamping element is thereby implemented in a manner that is structurally less prone to faults.

It can be provided that the anchor and/or the guide and/or the clamping element have a shape which is such that they can cause a motion of the clamping element that is not uniform over the stroke length of the frame. Also variable motion sequences can be implemented with this embodiment.

It is provided in one embodiment that the clamping element comprises a friction element on a side facing the receptacle, where the friction element comprises an outer surface with a material having a high coefficient of friction with respect to the material of the packaging blank. The packaging blank can consist of in particular cardboard, natural fiber, paper, bamboo or plastic material or comprise such. Due to a high coefficient of friction, in particular a high coefficient of sliding friction of the friction element with respect to the material of the packaging blank, the pressing force of the clamping element on the packaging blank can remain relatively low while reliable fixation can be ensured at the same time. Damage to the packaging blank is thus prevented.

Furthermore, the frame can comprise an opening corresponding to the receptacle so that a packaging blank passes through the opening when the frame is moved towards the lower tool. In this way, reliable attachment to or interaction with the lower tool can be realized despite the necessary function of the frame for actuating the clamping mechanism.

It is provided in one embodiment that the frame is connected to the lower tool by way of a restoring element which can cause the frame to be restored to an initial position when the lower tool and the upper tool are moved apart, and/or that the clamping mechanism comprises a restoring element which causes the clamping element to be restored to a release position when the lower tool and the frame are moved apart. A periodically recurring sequence of motions can thus be ensured.

### BRIEF DESCRIPTION OF THE DRAWINGS

FIG. 1 shows a schematic view of a molding station according to an embodiment;

FIG. 2 shows a more detailed view of the lower tool and the frame of FIG. 1 according to an embodiment; and

FIGS. 3A-E show the sequence of motions when the packaging trays are molded by way of a molding station according to an embodiment.

### DETAILED DESCRIPTION

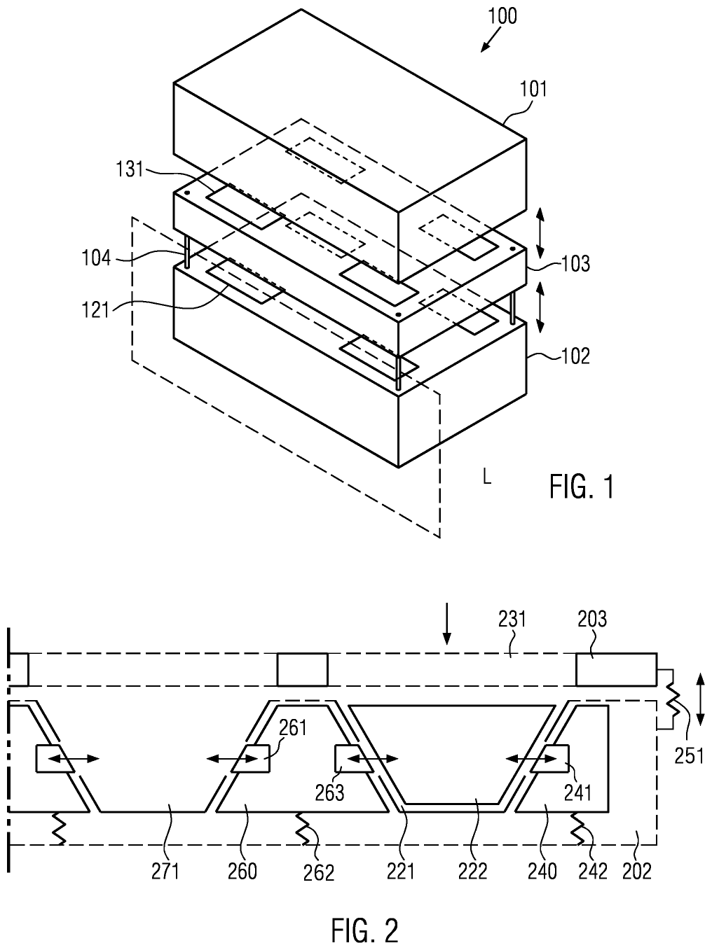

FIG. 1 shows an embodiment of a molding station 100 as it can be employed in the context of some embodiments. The molding station is shown there isolated from other devices, which shall be discussed briefly hereafter.

According to the embodiment presently shown, the molding station basically comprises a lower tool 102, an upper tool 101, and a frame 103 arranged therebetween.

Molding station 100 is used to mold packaging trays (presently not shown). Such packaging trays are to be understood hereafter as the combination of a packaging blank (for example, a blank made of cardboard, plastic material, natural materials such as bamboo or natural fibers or the like) and a film or other material layer molded thereonto. To mold the packaging tray, the film or other material layer is made to contact the packaging blank so that the film or the material layer molds onto the contour, in particular the inner contour, of the packaging blank.

A packaging blank made of cardboard can be seen as an example in which a plastic film is molded on with the aid of the molding station in order to make the packaging tray thus produced impermeable to water or other liquids.

For this purpose, lower tool 102 and upper tool 101 interact in such a way that one or more packaging blanks are introduced into receptacles 121 of lower tool 102 shown in FIG. 1 and a film is positioned relative to the packaging blanks in receptacles 121 with the aid of upper tool 101. For this purpose, upper tool 101 is moved relative to lower tool 102, so that they approach each other until a touching contact is given.

The film thereafter can be drawn off upper tool 101, for example, by applying a vacuum in the receptacles of lower tool 102 and sucked in the direction of the packaging blank onto which the film can then be molded. For this purpose, the film (or other material layer) can also be heated, for example, using heating elements provided in upper tool 101. It is furthermore possible that, in addition to the vacuum caused by lower tool 102, a gas flow is emitted from upper tool 101 in the direction of the film in order to additionally move the film in the direction of the packaging blank and to detach it from upper tool 101.

A frame 103 is arranged between upper tool 101 and lower tool 102 and is connected to lower tool 102 in a movable manner, for example, by way of connecting elements 104, but does not necessarily have a connection to upper tool 101. If upper tool 101 is now moved in the direction of lower tool 102, then frame 103 is “entrained” in the direction of the lower tool.

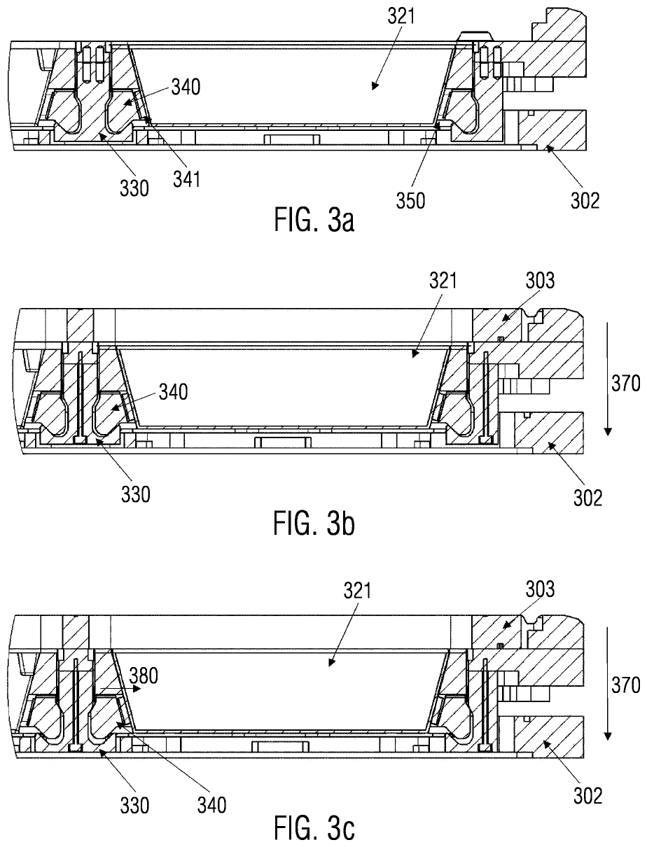

Frame 103 can comprise openings 131 which in terms of their size match receptacles 121 and in particular upper openings of receptacles 121 and are congruent therewith (can be seen in the perspective view and shown in more detail in FIG. 2), so that the film positioned by upper tool 101 above frame 103 (at least in the orientation that is shown in FIG. 1) can be moved in the direction of the packaging blanks disposed in receptacles 121 in order to thus mold the packaging trays.

Upper tool 101, frame 103, and the lower tool are preferably in touching contact in this order when the vacuum is applied to mold the packaging trays, so that the suction effect of the vacuum attracts the film (or other material layer) as completely as possible through the packaging blank.

Molding station 100 presently shown can be configured as a fully automated molding station as part of a larger molding machine. For this purpose, a supply device can be arranged e.g., (in terms of a process direction in which the packaging blanks and/or packaging trays are transported) upstream of molding station 100 and supplies packaging blanks to receptacles 121 of lower tool 102. A removal device can then be arranged downstream of molding station 100 and remove the molded packaging trays from receptacles 121. The entire process can run cyclically so that new packaging blanks are supplied and molded packaging trays are removed from the molding station in a fully automated manner.

Alternatively, the molding station can also be configured as part of a molding machine operated manually or in a semi-automated manner. For example, the supply device or the removal device can be omitted and the packaging blanks can be supplied or the packaging trays can be removed manually. It is also conceivable that both the supply of the packaging blanks as well as the removal of the packaging trays take place manually in that an operator inserts the packaging blank, then operates the molding station, and subsequently removes the molded packaging trays from the molding station.

The disclosure is not restricted in this regard.

FIG. 2 shows a more detailed view of lower tool 202 and frame 203 viewed onto section plane L which runs at least through a row of receptacles 221 and 271 (corresponding to 121 in FIG. 1) arranged next to one another in section plane L.

For the sake of simplicity, the outer region of lower tool 202 is shown in dashed lines in the view shown in FIG. 2. It goes without saying that this region can also be filled at least in part with material of lower tool 202 or contain components which, however, are not described in detail hereafter.

As can presently be seen, frame 203 is arranged relative to lower tool 202 in such a way that the opening 231 of frame 203 matches receptacle 221 so that the resulting opening region of frame 203 and receptacle 221 is of such large size that a packaging blank 222 arranged in receptacle 221 could be removed through the resulting opening region. This enables the introduction of the film from above (arrow) by way of the upper tool over the entire size of the packaging blank in receptacle 221.

It is provided in one embodiment that lower tool 221 comprises a clamping mechanism 240, 260. This clamping mechanism is configured such that it can be actuated by a motion of frame 203 in the direction of lower tool 202 so that a clamping element 241, 261, 263 of the clamping mechanism is moved in the direction toward the packaging blank in receptacle 221. This motion takes place in such a way that the clamping element touches the packaging blank at least at a position of frame 203 that is lowered maximally onto the lower tool.

This can cause the fixation of packaging blank 222 in receptacle 221. With this fixation, it is possible to reliably introduce the film (or other layer of material) and to mold the packaging tray, since a motion of the packaging blank relative to receptacle 221 is prevented.

If the fixation is maintained with the aid of the clamping element when the upper tool is already moving away from frame 203 (in the direction opposite to the direction of the arrow shown), it can also be ensured that complete detachment of film residues carried along by the upper tool from the packaging tray is caused, without the packaging tray moving within receptacle 221 or being entrained with the upper tool.

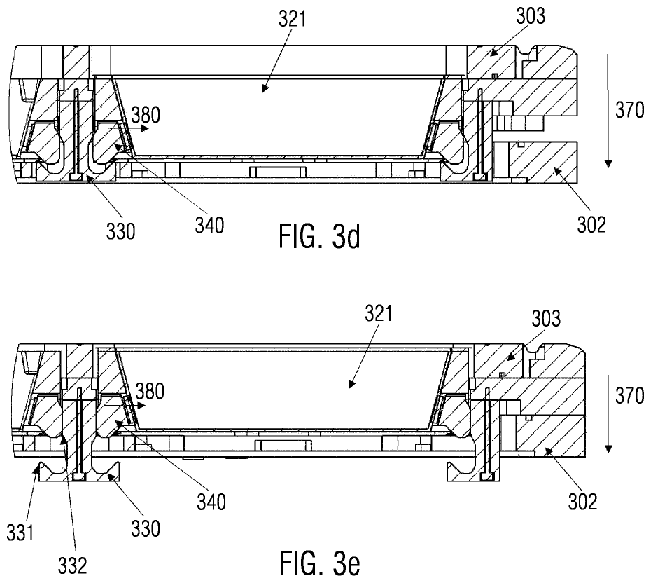

The more precise configuration of the clamping mechanism is described with reference to FIG. 3.

In the embodiment shown in FIG. 2, clamping mechanism 240 comprises only one clamping element 241 and in this sense can be used, for example, as an outermost clamping mechanism. Clamping mechanisms disposed farther inwardly, such as clamping mechanism 260, can comprise two clamping elements 261, 262 which can each be configured for the fixation of packaging blanks in adjacent receptacles 221, 271. Alternatively, two separate clamping mechanisms, corresponding to clamping mechanism 240 and each with only one clamping element, can also be provided in the region of clamping mechanism 260 presently shown.

It can also be provided that a clamping mechanism comprises more than two clamping elements. In this sense, four receptacles 121 are shown in lower tool 102 in FIG. 1. The clamping mechanism can extend through the lower tool in a direction perpendicular to plane L to such an extent that not only the receptacles adjacent in the direction from left to right presently shown and the packaging blanks arranged therein, but also receptacles adjacent thereto in a direction perpendicular thereto and packaging blanks arranged therein can interact with the same clamping mechanism, where one clamping element is provided for each receptacle and the packaging blank arranged therein.

This means that a clamping mechanism 260 according to FIG. 2 can comprise two clamping elements 261, 263 presently shown and further clamping elements in a further plane parallel to plane L which can each engage in a receptacle at the left and right of the clamping mechanism.

In this sense, clamping mechanism 260 acts as a common clamping mechanism for adjacent receptacles. This can be advantageous in particular when the lower tool comprises receptacles arranged at regular distances from one another.

It can be provided in particular that, when a common clamping mechanism is provided, the clamping elements of adjacent receptacles can be actuated simultaneously, which can ensure the synchronous fixation and/or synchronous release of the fixation of packaging blanks 222 in the corresponding receptacles.

As can be seen in FIG. 2, two oppositely disposed clamping elements are associated with each receptacle 221 in this embodiment. These are clamping elements 241, 263 for receptacle 221. This allows for the fixation of a packaging blank 222 in receptacle 221 on at least two oppositely disposed sides, whereby the central positioning of packaging blank 222 in receptacle 221 is also effected with a synchronous motion of the clamping elements.

However, the receptacles do not need to have an angular or rectangular shape, as shown in FIG. 1. They can also be configured to be round, oval, or triangular. Any shape of receptacles is conceivable there, so that any shape of the packaging blanks can be treated. However, the inner shape of the receptacle preferably corresponds to the outer shape of the packaging blank to be received therein.

If the shape of the receptacles and the corresponding shape of the packaging blank is a geometric shape that has no directly oppositely disposed sides (e.g., a triangular or pentagonal shape), one embodiment provides that at least two clamping elements 241 provided for receptacle 221, 263 have the maximum possible distance from one another, measured through the center point of receptacle 221, in order to realize points of engagement at the packaging blank that are as far apart as possible from one another. A push of the packaging blank in one direction within the receptacle can then be prevented.

In some embodiments, for example, also that shown in FIG. 2, clamping mechanism 240 can comprise a restoring element 242. The same applies to clamping mechanism 260 and associated restoring element 262. This restoring element 242, 262 is provided to ensure the restoring of the clamping element when frame 203 is raised from lower tool 202 and thereby the reliable release of the fixation of the packaging blank. This restoring element 242, 262 can be configured, for example, as a spring element. The spring element can comprise a spring (for example a metal spring) but also an elastic element, for example, made of rubber or polyurethane, which, when compressed, exerts a force acting against the compression. However, it can also be configured in such a way that an upward motion of frame 203 moves a driver which takes clamping element 241 (and similarly the other clamping elements) back to the release position in which the clamping element causes no fixation of the packaging blank.

Frame 203 can be connected in a movable manner to the lower tool by way of a further restoring element 251. This restoring element can be configured such that raising upper tool, presently not shown, (see FIG. 1) also causes frame 203 to be raised by a restoring force of restoring element 251. This causes the frame to be released from lower tool 202 after upper tool 101 has been raised so that the frame is raised from lower tool 202. This can simultaneously cause a restoring action of clamping element 241 of clamping mechanism 240, for example, also in interaction with restoring element 242.

FIGS. 3A-3E show an embodiment of the sequence of motion when the frame is lowered in the direction of lower tool 202. A separate illustration of the restoring elements has been dispensed with there. However, they can also be implemented in this embodiment in accordance with the embodiments described in the context of FIG. 2.

In the embodiment shown in FIG. 3, FIG. 3A shows an initial situation in which the frame is not yet in contact with lower tool 302. A receptacle 321 is shown in FIG. 3A with a packaging blank arranged therein. As already explained with reference to FIG. 2, clamping mechanisms are respectively provided on the left and the right of receptacle 321. In the embodiment shown there, each clamping mechanism comprises an anchor 330 as well as a clamping element 340 which is mounted in a guide 350 in a movable manner so that it can be moved in the direction of receptacle 321 or away therefrom.

For this purpose, anchor 330 and clamping element 340 are configured such that a downward motion of the anchor is converted into a motion of clamping element 340 towards receptacle 321, as shall be described hereafter.

In the embodiment presently shown, the motion of clamping element 340 only takes place horizontally. However, embodiments are also conceivable in which the clamping element is also moved in the vertical direction. Downward motions of the clamping element can there be preferred (at least in the viewing direction presently shown), since such a packaging blank in receptacle 321 is drawn against the base of the receptacle and not moved away therefrom (which would be the case if the clamping element moved upwardly in the image), which could be disadvantageous in the subsequent molding of the packaging tray.

In the embodiment presently shown, clamping elements 340 furthermore comprise an optional friction element 341. Friction element 341 is arranged on the side of clamping element 340 which points in the direction of receptacle 321. This can be either a separate component of clamping element 340, which is optionally releasably connected to the latter (by way of an adhesive element or a screw element or a plug element or the like), or the friction element can already itself be integrated into the clamping element as part of the surface of the clamping element. In principle, it can be provided that friction element 341 has a high coefficient of static friction with respect to the material of the packaging blank, i.e., for example, with respect to cardboard, natural fibers, bamboo, plastic material or the like. A high coefficient of static friction is regarded to be a coefficient of static friction whose value is at least 10%, preferably 20%, particularly preferably at least 50% greater than the coefficient of static friction of at least one further material component of the molding station that comes into contact with the packaging blank, in particular receptacle 321. In particular, the coefficient of static friction of the friction element can be greater than 0.8, preferably greater than 0.9, particularly preferably greater than 0.95 with respect to the material of the packaging blank. Friction element 341 can consist in particular of rubber or polyurethane or comprise a surface facing the receptacle made of or comprising at least one of these materials. The fixated packaging blank can be prevented in this way from slipping despite a small clamping force acting in the direction of receptacle 321 which is exerted by the clamping element onto the packaging blank. Damage to the packaging blank can thus be reduced.

FIG. 3B now shows a method step carried out chronologically after FIG. 3A in which frame 303 was moved in direction 370 toward lower tool 302 and therefore also in the direction of receptacle 321. In FIG. 3B, frame 303 is in touching contact with lower tool 302, but does not yet exert any force in the direction toward anchor 330 so that the latter is still disposed in its basic position shown in FIG. 1 and the clamping elements are also still disposed in the position shown in FIG. 1.

A further motion of frame 303 in direction 370 towards lower tool 302 now takes place in FIG. 3C, so that anchor 330 begins to sink downwardly in direction 370 because frame 303 pushes the anchor downwardly in direction 370. Due to the profile of the anchor and the profile of clamping element 340, the clamping element in guide 350 (see FIG. 3A) is now moved horizontal direction 380 towards receptacle 321. As can be seen in FIG. 3C, the anchor comprises a bulge of material which moves the clamping element towards receptacle 321 when the anchor is pressed down by frame 303 in guide 350.

This process continues in FIG. 3D, while frame 303 is moved further in direction 370 towards lower tool 302 and as long as the anchor still comprises a bulge of material that continues on the outside (viewed from the central axis of the anchor). As can be seen in FIG. 3D, the profile/bulge of material of anchor 330 consists of a material structure which bulges in the direction of receptacle 321. However, it has a maximum bulge and thereafter continues vertically (as can be seen in FIG. 3D).

This has the effect that anchor 330 slides along clamping element 340 without the latter being moved further in direction 380 when frame 303 is subsequently moved further in direction 370. Clamping element 340 is therefore held in the clamping position by anchor 330, in spite of the further motion of the frame, in order, for example, to prevent excessive clamping forces on a packaging blank in receptacle 321. This is shown in FIG. 3E.

In order to prevent the clamping element from projecting too far out of the guide and damage to the packaging blank then possibly occurring, it can be provided that a stop is formed in guide 350 against which a part of clamping element 340 strikes when moving in the direction of receptacle 321 (in direction 380) when the maximum amplitude of motion of the clamping element in direction 380 has been reached. For this purpose, clamping element 340 can comprise respective projections or similar elements projecting from the outer shape of the clamping element. A corresponding second stop can also be provided for defining the release position into which the clamping element has moved, for example, in FIG. 3A. This prevents the clamping element from sinking too far into guide 350 whereby problems with the motion of the clamping element along the outer contour of the anchor (for example, canting) can be prevented.

It can be provided in general that either the guide shown in FIG. 3 and/or the clamping element and/or the anchor have such a shape that the motion of clamping element 340 does not take place over the entire stroke of frame 303 along direction 370, or in particular no uniform motion of the clamping element is caused.

This can be set, for example, by selecting the angle of incidence of the profile/bulge of material of the anchor. A small angle relative to the horizontal (for example 10°, 20° or 30°) causes a strong motion of the clamping element in direction 380. A larger angle of, for example, 45° or greater than 45°, such as 65°, only causes a moderate motion of clamping element 340 in direction 380. If there is no profile/bulge of material of the anchor provided in the vertical direction, then this does not cause any motion of the clamping element in the embodiment presently shown.

A respective selection of the outer contour of the clamping element and, for example, alternating regions of a profile/bulge of material that is in communication with the anchor, can presently also influence the motion of the clamping element. The alignment of the guide, which limits the motion of clamping element 340, can also influence the motion of the clamping element in direction 380.

It can be seen in FIG. 3E that anchor 330, in addition to upper material contouring 332 which has just been discussed, also comprises a driver element 331 at the lower end of the anchor.

As can be seen in FIGS. 3A and 3B, this driver element 331 can engage clamping element 340 from below and, when anchor 330 is moved upwardly again (in the direction opposite to direction 370), cause clamping element 340 to be entrained in a direction that is opposite to direction 380, so that the clamping element is removed from the receptacle when anchor 330 is moved upwardly. The upwardly motion can be caused, for example, by the restoring element already described with reference to FIG. 2 which can be connected to anchor 330 for this purpose and, when frame 303 is raised, can cause the anchor to be raised in a direction opposite to direction 370.

As a result, clamping element 340 is moved in the opposite direction and the packaging tray molded in the receptacle can be released.

While the clamping mechanism in the embodiment presently shown comprises an anchor and a clamping element movable by this anchor, where the motion is caused in particular by the interaction with the outer contour of the anchor in guide 350 as well as the contour of clamping element 340, other configurations of the clamping mechanism are presently also conceivable.

For example, guided angle elements or rotary elements that can be moved along direction 370 can also be provided as part of the clamping mechanism. For example, instead of the anchor, a screw can be arranged in a thread that extends in direction 370, where the screw has a rotationally non-symmetrical shape that deviates from the cylindrical shape in a region of the thread that is exposed towards receptacle 321 and that can actuate the clamping element during continuous rotation. In cross section, such a screw can have, for example, an oval shape or a teardrop shape so that, when the screw is rotated, the clamping element is moved when running along the contour of the screw.

The exact implementation of the clamping mechanism is presently not restricted. For some embodiments, however, it is essential that the clamping mechanism be operated preferably solely by the actuation of the frame or the movement of the frame in the direction of the lower tool, without further drive elements being provided for this purpose such as separate electrical drives for the clamping mechanism. In this sense, the clamping mechanism can be understood to be a passive clamping mechanism.

What is claimed is:

1. A molding station for molding packaging trays, the molding station comprising:
an upper tool and a lower tool which can be moved relative to one another; and
a frame that is connected to the lower tool in a movable manner and that is arranged between the upper tool and the lower tool;
wherein the lower tool comprises a receptacle for a packaging blank and a clamping mechanism for fixating the packaging blank in the receptacle, and the clamping mechanism comprises a clamping element which can be actuated by a motion of the frame relative to the lower tool and is configured to fixate the packaging blank in the receptacle.

2. The molding station according to claim 1, wherein the clamping mechanism comprises a movable anchor and the clamping element is arranged in a guide, wherein the clamping mechanism is configured to convert a motion of the frame relative to the lower tool into a motion of the anchor and, due to the motion of the anchor, to cause a motion of the clamping element in the guide.

3. The molding station according to claim 2, wherein the anchor and/or the guide and/or the clamping element has/have a shape configured to cause a motion of the clamping element that is not uniform over a length of a stroke of the frame.

4. The molding station according to claim 1, wherein the lower tool comprises an additional receptacle, and the clamping mechanism is configured as a common clamping mechanism for fixation of packaging blanks in the receptacles.

5. The molding station according to claim 4, wherein the common clamping mechanism comprises an additional clamping element associated with one of the receptacles, and wherein the clamping elements can be actuated simultaneously by the motion of the frame relative to the lower tool.

6. The molding station according to claim 1, wherein the lower tool comprises an additional clamping mechanism associated with the receptacle, and the additional clamping mechanism comprises an additional clamping element, and wherein the clamping elements are arranged to fixate the packaging blank on opposite sides.

7. The molding station according to claim 1, wherein the clamping element comprises a friction element on a side facing the receptacle, wherein the friction element comprises an outer surface with a material having a high coefficient of friction with respect to at least one of cardboard, natural fiber, paper, bamboo, plastic material.

8. The molding station according to claim 1, wherein the frame comprises an opening corresponding to the receptacle so that a packaging blank can pass through the opening when the frame is moved towards the lower tool.

9. The molding station according to claim 1, wherein the frame is connected to the lower tool by a restoring element which can cause the frame to be restored to an initial position when the lower tool and the upper tool are moved apart.

10. The molding station according to claim 9, wherein the clamping mechanism comprises a restoring element which can cause the clamping element to be restored to a release position when the lower tool and the frame are moved apart.

11. The molding station according to claim 1, wherein the clamping mechanism comprises a restoring element which can cause the clamping element to be restored to a release position when the lower tool and the frame are moved apart.

12. A method for molding packaging trays by way of a molding station, wherein the molding station comprises an upper tool and a lower tool which are movable relative to one another, and a frame that is connected to the lower tool in a movable manner and that is arranged between the upper tool and the lower tool, wherein the lower tool comprises a receptacle for a packaging blank and a clamping mechanism for fixating the packaging blank in the receptacle, and wherein the clamping mechanism comprises a clamping element which is actuatable by a motion of the frame relative to the lower tool and configured to fixate the packaging blank in the receptacle, the method comprising:
moving the frame in a direction of the lower tool by a motion of the lower tool and the upper tool towards one another, so that the clamping element is thereby actuated for fixating the packaging blank in the receptacle.

13. The method according to claim 12, wherein the clamping mechanism comprises a movable anchor and the clamping element is arranged in a guide, wherein the clamping mechanism converts a motion of the frame relative to the lower tool into a motion of the anchor and, wherein the motion of the anchor causes a motion of the clamping element in the guide.

14. The method according to claim 13, wherein the anchor and/or the guide and/or the clamping element has/have a shape to cause a motion of the clamping element that is not uniform over a length of a stroke of the frame.

15. The method according to claim 12, wherein the clamping element comprises a friction element on a side facing the receptacle, where the friction element comprises an outer surface with a material having a high coefficient of friction with respect to the material of the packaging blank.

16. The method according to claim 12, wherein the frame comprises an opening corresponding to the receptacle so that the packaging blank can pass through the opening when the frame is moved towards the lower tool.

17. The method according to claim 12, wherein the frame is connected to the lower tool by a restoring element which causes the frame to be restored to an initial position when the lower tool and the upper tool are moved apart.

18. The method according to claim 17, wherein the clamping mechanism comprises a restoring element which causes the clamping element to be restored to a release position when the lower tool and the frame are moved apart.

19. The method according to claim 12, wherein the clamping mechanism comprises a restoring element which causes the clamping element to be restored to a release position when the lower tool and the frame are moved apart.

20. A method for molding packaging trays by a molding station, wherein the molding station comprises an upper tool and a lower tool, and a frame that is connected to the lower tool in a movable manner and that is arranged between the upper tool and the lower tool, wherein the lower tool comprises a receptacle for a packaging blank and a clamping mechanism for fixating the packaging blank in the receptacle, the method comprising:
moving the frame in a direction of the lower tool by a motion of the upper tool relative to the lower tool, so that a clamping element of the clamping mechanism is thereby actuated for fixating the packaging blank in the receptacle.
